(19) United States
(12) Patent Application Publication
(10) Pub. No.: US 2025/0312658 A1
(43) Pub. Date: Oct. 9, 2025

(54) SELF-INFLATING BALL

(71) Applicant: CHANGTAI JIEYU SPORTS EQUIPMENT CO., LTD., Zhangzhou (CN)

(72) Inventors: Chih-Yuan Yeh, Zhangzhou (CN); Chien-Liang Yeh, Zhangzhou (CN)

(21) Appl. No.: 19/243,762

(22) Filed: Jun. 20, 2025

Related U.S. Application Data
(63) Continuation-in-part of application No. PCT/CN2023/136349, filed on Dec. 5, 2023.

(30) Foreign Application Priority Data
Dec. 21, 2022 (CN) 202211649361.X

(51) Int. Cl. A63B 41/00

(52) U.S. Cl. CPC A63B 41/00

(57) ABSTRACT

A self-inflating ball includes a hollow ball body. The hollow ball body is an elastic ball body capable of elastic deformation. The hollow ball body has at least one vent hole formed in a wall of the hollow ball body. The vent hole passes through the inner and outer sides of the hollow ball body in a wall-thickness direction of the hollow ball body. When the self-inflating ball is to be deflated, the self-inflating ball is compressed by an external force to discharge air inside the hollow ball body via the vent hole, thereby flattening the hollow ball body. When the self-inflating ball is to be inflated and the hollow ball body is under compression, removal of the external force allows the hollow ball body to undergo elastic deformation due to its own resilience and return to its original shape.

### BACKGROUND OF THE INVENTION

### 1. Field of the Invention

The present invention relates to a rubber ball, and more particularly to a self-inflating ball.

### 2. Description of the Prior Art

There are two main types of rubber balls on the market. One is an inflatable rubber ball, such as soccer balls and basketballs, which has a valve on the ball. When the internal air of the ball is not enough, an air pump and a needle are required for inflating the ball. The other is a sealed rubber ball. The ball is a one-piece structure, without a valve. After leaking, the ball cannot be re-inflated and can no longer be used.

Rubber balls, including toy rubber balls, often need to be flattened to reduce their size to save on shipping costs. However, they need to be inflated when they are sold or when in use. Besides, inflatable toy balls need to be re-inflated after a leak.

A conventional inflatable rubber ball has the following problems in inflating: (1) it needs an air pump, which increases the cost; (2) the air pump is not commonly used and may be lost, affecting the subsequent pumping; (3) the air pump is not suitable for use by children, which reduces the experience of the children playing with the rubber ball.

Accordingly, the inventor of the present invention has devoted himself based on his many years of practical experiences to solve these problems.

### SUMMARY OF THE INVENTION

In view of the deficiencies of the prior art, the primary object of the present invention is to provide a self-inflating ball, which realizes the self-inflation of the ball without the need for an air pump, has a better user experience, is able to recover quickly, and has good resilience.

In order to achieve the above object, the present invention adopts the following solutions.

A self-inflating ball comprises a hollow ball body. The hollow ball body is an elastic ball body capable of elastic deformation. The hollow ball body has at least one vent hole integrally formed in a wall of the hollow ball body. The vent hole passes through inner and outer sides of the hollow ball body in a wall-thickness direction of the hollow ball body.

When the self-inflating ball is to be deflated, the self-inflating ball is compressed by an external force to discharge air inside the hollow ball body via the vent hole, thereby flattening the hollow ball body.

When the self-inflating ball is to be inflated and the hollow ball body is under compression, removal of the external force allows the hollow ball body to undergo elastic deformation due to its own resilience and return to its original shape. During recovery of the hollow ball body, external air enters the hollow ball body via the vent hole.

The hollow ball body has an average outer diameter defined as a ball diameter D.

The hollow ball body has an average wall thickness T satisfying the following function:

T=T₁₂₇× (D/127)^{M}, in the function: T₁₂₇∈[3.2 mm, 4.1 mm], D is the ball diameter, T₁₂₇ is the average wall thickness when the ball diameter D is 127 mm, M∈[0.8, 1.0].

The vent hole of the hollow ball body has a hole diameter H satisfying the following function:

H=H₁₂₇× (D/127)^{0.5}, in the function: H₁₂₇∈[2.5 mm, 4.0 mm], D is the ball diameter, H₁₂₇ is the hole diameter when the ball diameter D is 127 mm.

Preferably, the ball diameter D is 125-300 mm.

Preferably, the wall thickness T is 2.0-10.0 mm.

Preferably, the hole diameter H is 1.5-6.0 mm.

Preferably, the T₁₂₇ is 3.7 mm, and the H₁₂₇ is 4.0 mm.

Preferably, the vent hole has a circular cross-section.

Preferably, the hollow ball body is made of elastic rubber.

Preferably, a reinforcing protrusion is integrally formed on an inner wall and/or outer wall of the hollow ball body, surrounding an outer periphery of the vent hole.

Preferably, the at least one vent hole includes two vent holes.

Preferably, the hollow ball body after inflation has a rebound rate of greater than or equal to 48%. The rebound rate is the ratio of a height to which the hollow ball body bounces to a height from which the hollow ball body is dropped. The height from which the hollow ball body is dropped is 150 cm.

Compared with the prior art, the present invention has obvious advantages and beneficial effects. Specifically, the feature of the present invention is that the self-inflating ball is designed to have a hollow ball body. The hollow ball body is an elastic ball body capable of elastic deformation. The hollow ball body has at least one vent hole integrally formed in the wall of the hollow ball body. The vent hole passes through the inner and outer sides of the hollow ball body in the wall-thickness direction of the hollow ball body. When the hollow ball body is under compression, removal of the external force allows the hollow ball body to undergo elastic deformation due to its own resilience and return to its original shape. During the recovery of the hollow ball body, external air automatically enters the hollow ball body via the vent hole. In this way, the ball can be inflated automatically without the need for an air pump, providing a better user experience. The average wall thickness T of the hollow ball body satisfies the following function: T=T₁₂₇×(D/127)^{M}. The hole diameter H of the vent hole of the hollow ball body satisfies the following function: H=H₁₂₇×(D/127)^{0.5}. This ensures that the hollow ball body after inflation has a good rebound rate and a short recovery time so that the ball can recover quickly and have good resilience. The self-inflating ball only has the hollow ball body and the vent hole that is integrally formed in the hollow ball body. There is no need for an inflation valve disposed on the ball. The structure of the ball is simple and ingenious. It is easy to form and manufacture the self-inflating ball.

### BRIEF DESCRIPTION OF THE DRAWINGS

Embodiments of the present invention will now be described, by way of example only, with reference to the accompanying drawings.

FIG. 1 is a front view of the self-inflating ball according to a preferred embodiment of the present invention;

FIG. 2 is a cross-sectional view of the self-inflating ball according to the preferred embodiment of the present invention;

FIG. 3 is a partial cross-sectional view of the self-inflating ball according to the preferred embodiment of the present invention, wherein the reinforcing protrusion is integrally formed on the outer wall of the hollow ball body;

FIG. 4 is a partial cross-sectional view of the self-inflating ball according to the preferred embodiment of the present invention, wherein the reinforcing protrusion is integrally formed on the inner wall of the hollow ball body;

FIG. 5 is a partial cross-sectional view of the self-inflating ball according to the preferred embodiment of the present invention, wherein the reinforcing protrusion is integrally formed on both the inner wall and the outer wall of the hollow ball body;

FIG. 6 is a graph illustrating the suggested range of the hole diameter H corresponding to the ball diameter D according to the preferred embodiment of the present invention; and

FIG. 7 is a graph illustrating the suggested range of the wall thickness T corresponding to the ball diameter D.

### DETAILED DESCRIPTION OF THE PREFERRED EMBODIMENTS

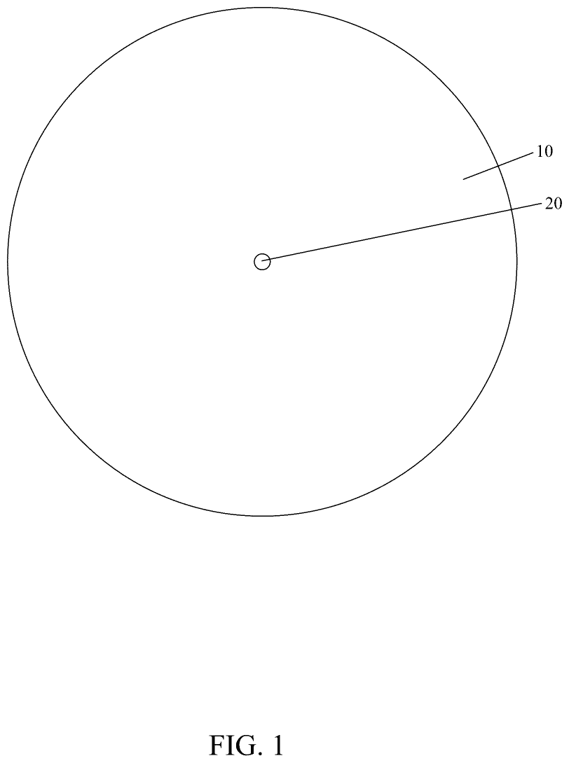

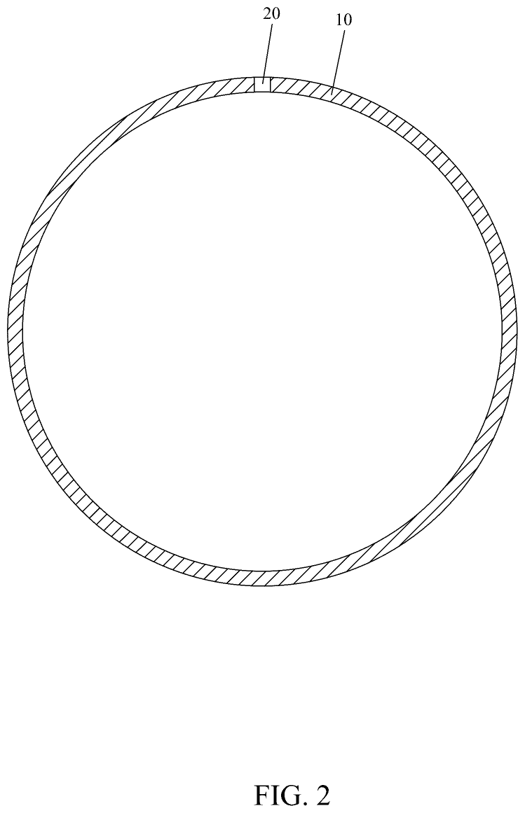

Referring to FIG. 1 through FIG. 5, the present invention discloses a self-inflating ball.

The self-inflating ball comprises a hollow ball body 10. The hollow ball body 10 is an elastic ball body capable of elastic deformation. Preferably, the ball is a rubber ball. The hollow ball body 10 has at least one vent hole 20 integrally formed in the wall of the hollow ball body 10. The vent hole 20 passes through the inner and outer sides of the hollow ball body 10 in the wall-thickness direction of the hollow ball body 10. The inner peripheral side wall of the vent hole 20 is the wall of the hollow ball body 10. In this way, the vent hole 20 of the rubber ball is kept open when the rubber ball is in a natural state. The rubber ball only has the hollow ball body 10 and the vent hole 20 that is integrally formed in the hollow ball body 10. There is no need for an inflation valve disposed on the ball. The structure of the ball is simple and ingenious. It is easy to form and manufacture the self-inflating ball. The hollow ball body 10 is made of elastic rubber using a combination of natural rubber and synthetic rubber. The hollow ball body 10 may be made of non-elastic rubber, such as TPU or TPE. The hollow ball body 10 may be made of other polymer materials with elasticity and resilience, as long as it can be elastically deformed.

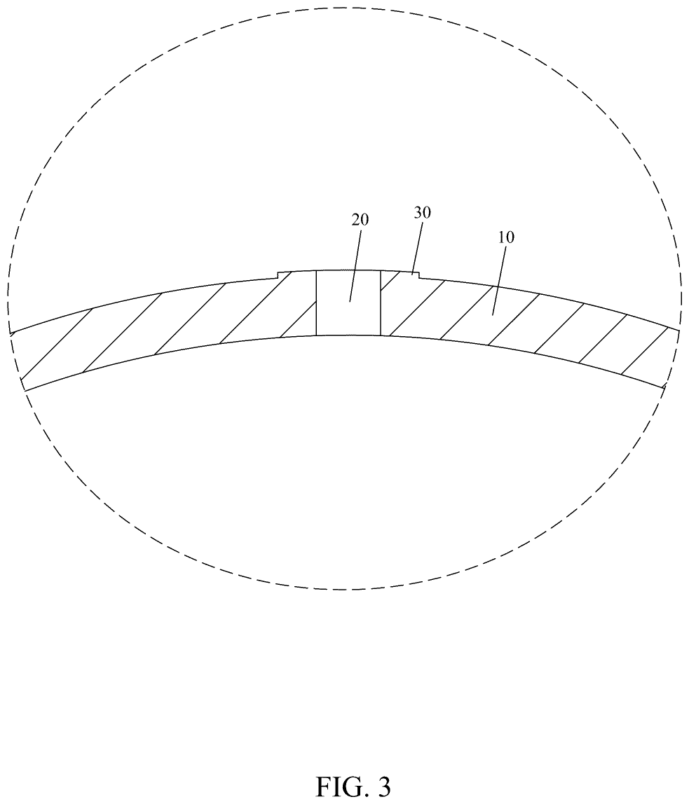

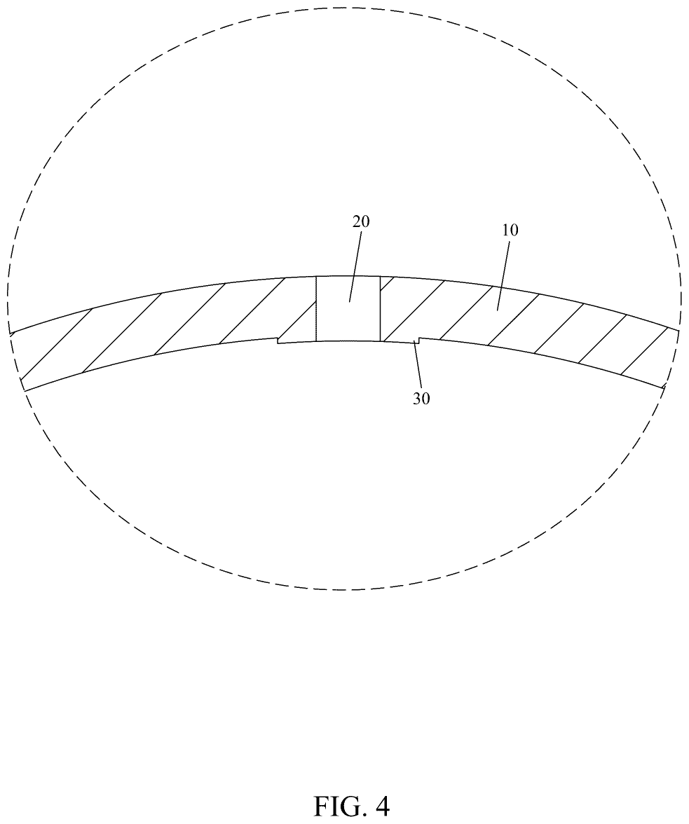

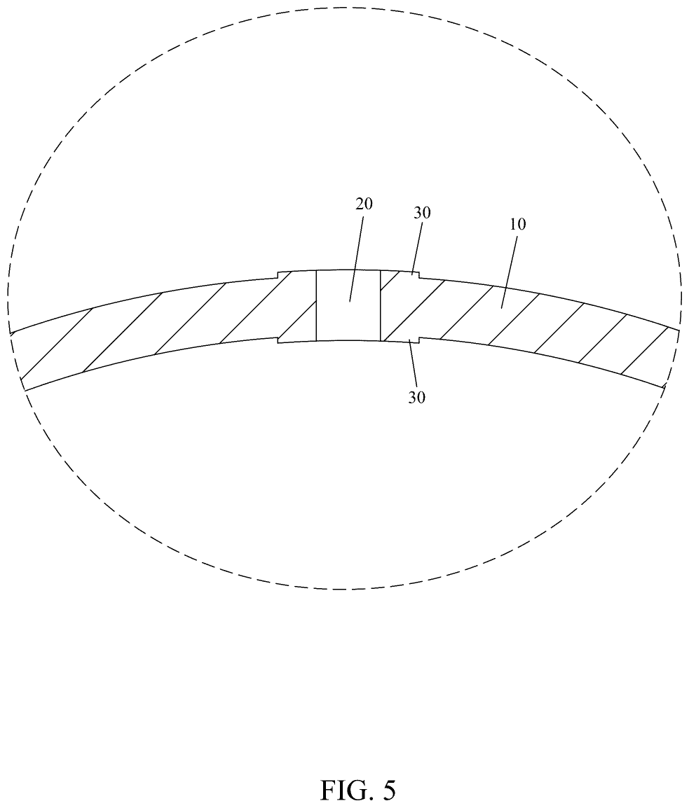

A reinforcing protrusion 30 is integrally formed on the inner wall and/or outer wall of the hollow ball body 10, surrounding the outer periphery of the vent hole 20. The reinforcing protrusion 30 is an annular structure surrounding the outer periphery of the vent hole 20. In this way, the outer periphery of the vent hole 20 can be strengthened and protected by the reinforcing protrusion 30, so as to avoid that when the vent hole 20 is deformed along with the hollow ball body 10, the vent hole 20 is susceptible to rupture due to squeeze, compression and deformation, resulting in the phenomenon that the hole diameter is relatively large. As shown in FIG. 3, the reinforcing protrusion 30 is integrally formed on the outer wall of the hollow ball body 10. As shown in FIG. 4, the reinforcing protrusion 30 is integrally formed on the inner wall of the hollow ball body 10. As shown in FIG. 5, the reinforcing protrusion 30 is integrally formed on both the inner wall and the outer wall of the hollow ball body 10. In practice, preferably, the reinforcing protrusion 30 is integrally formed on both the inner wall and the outer wall of the hollow ball body 10 to strengthen and protect the vent hole 20 better.

Preferably, the cross section of the vent hole 20 is circular. The cross-sectional diameter of the vent hole 20 may be the same or approximately the same throughout. The circular vent hole 20 is selected because if an angular shape (such as a triangle or a square) is used, it is prone to cause stress concentration during deformation of the hollow ball body 10, which may lead to material rupture and reduce the product's durability.

The air can be rapidly discharged during compression of the hollow ball body 10. Besides, the air can flow into the hollow ball body 10 again after the pressure is released. This process generates an internal airflow boosting effect on the inner wall of the hollow ball body 10, which in turn affects rebound efficiency. The larger the diameter of the vent hole 20 is, the faster the air in and out is, and the shorter the time required to restore the original shape after being flattened is. However, due to the large exhaust volume during compression, the internal air pressure is insufficient and the rebound force decreases. The smaller the diameter of the vent hole 20 is, the more restricted the air circulation is, and the slower the recovery speed after being flattened is. However, more internal air can be retained, creating a higher air pressure and improving bouncing performance. Preferably, the hole diameter H of the vent hole 20 is 1.5-6.0 mm. The hole diameter H needs to be balanced between elasticity and recovery time. The hollow ball body 10 may have two vent holes 20. The two vent holes 20 are symmetrically arranged in the diameter direction of the hollow ball body 10.

When the self-inflating ball is to be deflated, the self-inflating ball is compressed by an external force to discharge the air inside the hollow ball body 10 via the vent hole 20, thereby flattening the hollow ball body 10. When the self-inflating ball is to be inflated and the hollow ball body 10 is under compression, removal of the external force allows the hollow ball body 10 to undergo elastic deformation due to its own resilience and return to its original shape. During the recovery of the hollow ball body 10, external air enters the hollow ball body 10 via the vent hole 20. In this way, the rubber ball can be inflated automatically without the need for an air pump, providing a better user experience.

The rebound rate of the hollow ball body 10 after inflation is ≥48%. Preferably, the rebound rate of the hollow ball body 10 after inflation is ≥68%. The rebound rate is the ratio of the height to which the hollow ball body 10 bounces to the height from which the hollow ball body 10 is dropped. Preferably, the height from which the hollow ball body 10 is dropped is 150 cm. The method for testing the rebound rate is as follows: place the rubber ball after inflation at a height of 150 cm above the ground and let it fall freely. After hitting a tiled surface, the rubber ball will rebound to a certain height h. The rebound rate=(h/150)×100%.

The average outer diameter of the hollow ball body 10 is defined as a ball diameter D. Preferably, the ball diameter D is 125-300 mm for different ages and application scenarios. The average wall thickness T of the hollow ball body 10 is preferably 2.0-10.0 mm. The wall thickness may influence the support and bouncing performance.

To ensure a good rebound rate of the hollow ball body 10 after inflation at different ball diameters, once the value of the ball diameter D has been determined:

the average wall thickness T of the hollow ball body 10 satisfies the following function:

T=T₁₂₇×(D/127)^{M}, in the function: T₁₂₇∈[3.2 mm, 4.1 mm], D is the ball diameter, T₁₂₇ is the average wall thickness when the ball diameter D is 127 mm, M∈[0.8, 1.0], wherein, T₁₂₇ is preferably 3.7 mm, and M is 0.9 as an example;

The hole diameter H (taking a single hole as an example) of the vent hole 20 of the hollow ball body 10 satisfies the following function:

H=H₁₂₇× (D/127)^{0.5}, in the function: H₁₂₇∈[2.5 mm, 4.0 mm], D is the ball diameter, H₁₂₇ is the hole diameter when the ball diameter D is 127 mm, wherein, H₁₂₇ is preferably 4.0 mm.

Preferably, the suggested ranges of the wall thickness T and the hole diameter H corresponding to the ball diameter D are shown in the following table:

| ball diameter | suggested wall | suggested hole |
|---|---|---|
| D (mm) | thickness T (mm) | diameter H (mm) |
| 125 | 3.15-4.04 | 2.48-3.97 |
| 150 | 3.72-4.76 | 2.72-4.35 |
| 200 | 4.82-6.17 | 3.14-5.02 |
| 250 | 5.89-7.54 | 3.51-5.61 |
| 300 | 6.94-8.89 | 3.84-6.15 |

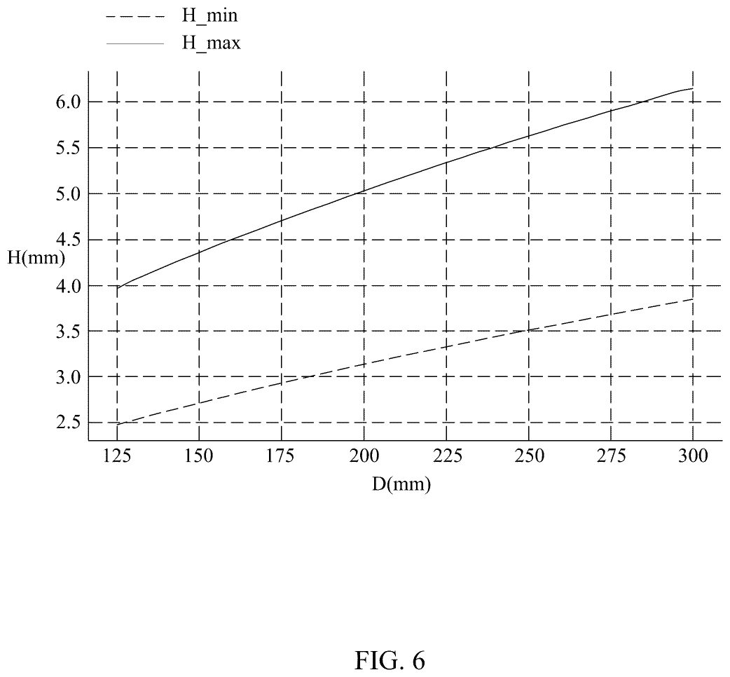

FIG. 6 illustrates the suggested range of the hole diameter H corresponding to the ball diameter D.

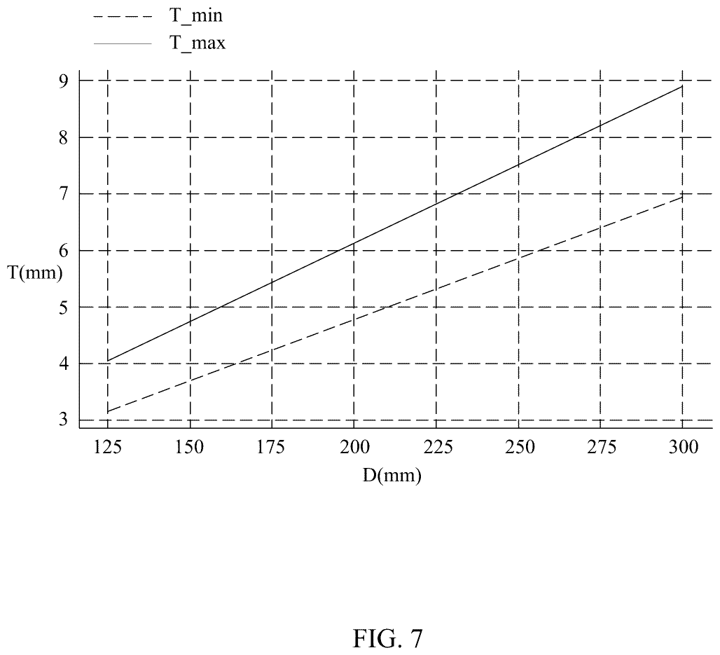

FIG. 7 illustrates the suggested range of the wall thickness T corresponding to the ball diameter D.

The present invention will be further described below in conjunction with specific embodiments.

The ball diameter D of the hollow ball body 10 is 127 mm. The wall thickness T of the hollow ball body 10 is 2.4/3.2/3.7/4.1 mm. The hole diameter H of the vent hole 20 of the hollow ball body 10 is 1.8/4/6 mm (one vent hole 20 and two vent holes 20). The weight W of the hollow ball body 10 is 153.7/210/218.8/228.38 g. The data of the rebound rate and the recovery time obtained by testing under the above parameters are shown in the following tables (the rebound rate=(h/150)×100%, and the recovery time TR is the number of seconds it takes for the hollow ball body 10 to return to its original shape after being flattened.

Table 1, the wall thickness is 4.1 mm.

| | | | rebound rate | recovery time |
|---|---|---|---|---|
| | wall | | the rebound height when | (second) after |
| | thickness | weight | the ball is dropped from | the ball is |
| A | (mm) | (g) | a height of 150 cm | flattened |
| one vent | | | | |
| hole diameter | | | | |
| 1.8 mm | 4.1 mm | 228.38 g | 72%(108/150 cm) | 4.66 s |
| 4 mm | 4.1 mm | 228.38 g | 69.3%(104/150 cm) | 4 S |
| 6 mm | 4.1 mm | 228.38 g | 65.3%(98/150 cm) | 1.5 S |
| | | | rebound rate | recovery time |
| | wall | | the rebound height when | (second) after |
| | thickness | weight | the ball is dropped from | the ball is |
| B | (mm) | (g) | a height of 150 cm | flattened |
| two vent | | | | |
| holes diameter | | | | |
| 1.8 mm*2 | 4.1 mm | 228.38 g | 68.7% (103/150 cm) | 1.75 s |
| 4 mm*2 | 4.1 mm | 228.38 g | 66%(99/150 cm) | 1.08 s |
| 6 mm*2 | 4.1 mm | 228.38 g | 61.3%(95/150 cm) | 0.55 s |

Table 2, the wall thickness is 3.7 mm.

| | | | rebound rate | recovery time |
|---|---|---|---|---|
| | wall | | the rebound height when | (second) after |
| | thickness | weight | the ball is dropped from | the ball is |
| A | (mm) | (g) | a height of 150 cm | flattened |
| one vent | | | | |
| hole diameter | | | | |
| 1.8 mm | 3.7 mm | 218.8 g | 70%(105/150 cm) | 4.61 s |
| 4 mm | 3.7 mm | 218.8 g | 69.1%(103/150 cm) | 1.33 s |
| 6 mm | 3.7 mm | 218.8 g | 66%(99/150 cm) | 0.74 s |
| | | | rebound rate | recovery time |
| | wall | | the rebound height when | (second) after |
| | thickness | weight | the ball is dropped from | the ball is |
| B | (mm) | (g) | a height of 150 cm | flattened |
| two vent | | | | |
| holes diameter | | | | |
| 1.8 mm*2 | 3.7 mm | 218.8 g | 68%(102/150 cm) | 1.55 s |
| 4 mm*2 | 3.7 mm | 218.8 g | 65.3%(99/150 cm) | 1 s |
| 6 mm*2 | 3.7 mm | 218.8 g | 59.3%(89/150 cm) | 0.46 s |

Table 3, the wall thickness is 3.2 mm.

| | | | rebound rate | recovery time |
|---|---|---|---|---|
| | wall | | the rebound height when | (second) after |
| | thickness | weight | the ball is dropped from | the ball is |
| A | (mm) | (g) | a height of 150 cm | flattened |
| one vent | | | | |
| hole diameter | | | | |
| 1.8 mm | 3.2 mm | 210 g | 68.7%(103/150 cm) | 4.33 s |
| 4 mm | 3.2 mm | 210 g | 68%(102/150 cm) | 1.51 s |
| 6 mm | 3.2 mm | 210 g | 67.3%(101/150 cm) | 1 s |
| | | | rebound rate | recovery time |
| | wall | | the rebound height when | (second) after |
| | thickness | weight | the ball is dropped from | the ball is |
| B | (mm) | (g) | a height of 150 cm | flattened |
| two vent | | | | |
| holes diameter | | | | |
| 1.8 mm*2 | 3.2 mm | 210 g | 68%(102/150 cm) | 1.85 s |
| 4 mm*2 | 3.2 mm | 210 g | 65.3%(98/150 cm) | 0.89 s |
| 6 mm*2 | 3.2 mm | 210 g | 63.3%(95/150 cm) | 0.73 s |

Table 4, the wall thickness is 2.4 mm.

| | | | rebound rate | recovery time |
|---|---|---|---|---|
| | wall | | the rebound height when | (second) after |
| | thickness | weight | the ball is dropped from | the ball is |
| A | (mm) | (g) | a height of 150 cm | flattened |
| one vent | | | | |
| hole diameter | | | | |
| 1.8 mm | 2.4 mm | 153.7 g | 68%(102/150 cm) | 6.78 s |
| 4 mm | 2.4 mm | 153.7 g | 66.6%(100/150 cm) | 2.44 s |
| 6 mm | 2.4 mm | 153.7 g | 58.6%(88/150 cm) | 0.88 s |
| | | | rebound rate | recovery time |
| | wall | | the rebound height when | (second) after |
| | thickness | weight | the ball is dropped from | the ball is |
| B | (mm) | (g) | a height of 150 cm | flattened |
| two vent | | | | |
| holes diameter | | | | |
| 1.8 mm*2 | 2.4 mm | 153.7 g | 66.6%(100/150 cm) | 2.65 s |
| 4 mm*2 | 2.4 mm | 153.7 g | 65.3%(98/150 cm) | 1.34 s |
| 6 mm*2 | 2.4 mm | 153.7 g | 55.3%(83/150 cm) | 0.78 s |

According to the data of the above tables of the rebound rate and the recovery time obtained by testing, the relationship between the weight W and the wall thickness T is that when the ball diameter D of the hollow ball body 10 is 127 mm, the weight Wis approximately linearly related to the wall thickness T: W≈K1×T, K1 is the proportional constant between the weight and the wall thickness, and according to the test data, K1 ∈[55 g/mm, 66 g/mm]. The relationship between the hole diameter H and the rebound rate is that the hole diameter H and the rebound rate R present a parabolic inverse relationship. If the hole diameter H is too large or too small, the performance will be affected. When the hole diameter H is in the range of 2.5 mm to 4 mm, the rebound rate requirements can be met. The relationship between the hole diameter H and the recovery time TR is that the recovery time TR is inversely proportional to the hole diameter H, TR≈K2/H, K2 is the inverse proportionality constant between the recovery time and the hole diameter, and according to the test data, K2∈[8,16]. Comprehensive performance ratio P: by combining the rebound rate R and the recovery time TR, the performance ratio is defined as P=R/TR as a comprehensive indicator. The combination of T=3.7 mm and H=4 mm shows the best performance. Thus, the optimal design range and parameter combinations are as follows:

When the ball diameter D is 127 mm, the following design parameters are: T∈[3.2 mm, 4.1 mm], wherein the optimal value is Topt=3.7 mm; H∈[2.5 mm, 4.0 mm], where the optimal value is Hopt=4.0 mm (single hole). Within this range, an ideal rebound rate and relatively fast recovery time can be ensured. Optimal value combination: Topt=3.7 mm, Hopt=4.0 mm (single hole), the rebound rate R≥68% (measured 69.1%), the recovery time TR≤1.5 s (measured 1.33 S), the performance ratio P≥45 (R is percentage, TR is seconds).

In summary, the feature of the present invention is that the self-inflating ball is designed to have a hollow ball body. The hollow ball body is an elastic ball body capable of elastic deformation. The hollow ball body has at least one vent hole integrally formed in the wall of the hollow ball body. The vent hole passes through the inner and outer sides of the hollow ball body in the wall-thickness direction of the hollow ball body. When the hollow ball body is under compression, removal of the external force allows the hollow ball body to undergo elastic deformation due to its own resilience and return to its original shape. During the recovery of the hollow ball body, external air automatically enters the hollow ball body via the vent hole. In this way, the ball can be inflated automatically without the need for an air pump, providing a great user experience. The average wall thickness T of the hollow ball body satisfies the following function: T=T₁₂₇×(D/127)^{M}. The hole diameter H of the vent hole of the hollow ball body satisfies the following function: H=H₁₂₇×(D/127)^{0.5}. This ensures that the hollow ball body after inflation has a good rebound rate and a short recovery time so that the ball can recover quickly and have good resilience. The self-inflating ball only has the hollow ball body and the vent hole that is integrally formed in the hollow ball body. There is no need for an inflation valve disposed on the ball. The structure of the ball is simple and ingenious. It is easy to form and manufacture the self-inflating ball.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A self-inflating ball, comprising a hollow ball body, the hollow ball body being an elastic ball body capable of elastic deformation, the hollow ball body having at least one vent hole integrally formed in a wall of the hollow ball body, the vent hole passing through inner and outer sides of the hollow ball body in a wall-thickness direction of the hollow ball body;
wherein when the self-inflating ball is to be deflated, the self-inflating ball is compressed by an external force to discharge air inside the hollow ball body via the vent hole, thereby flattening the hollow ball body;
wherein when the self-inflating ball is to be inflated and the hollow ball body is under compression, removal of the external force allows the hollow ball body to undergo elastic deformation due to its own resilience and return to an original shape of the hollow ball body, during recovery of the hollow ball body, external air enters the hollow ball body via the vent hole;
wherein the hollow ball body has an average outer diameter defined as a ball diameter D;
wherein the hollow ball body has an average wall thickness T satisfying the following function:
T=T₁₂₇× (D/127)^{M}, in the function: T₁₂₇∈[3.2 mm, 4.1 mm], D is the ball diameter, T₁₂₇ is the average wall thickness when the ball diameter D is 127 mm, M∈[0.8, 1.0];
wherein the vent hole of the hollow ball body has a hole diameter H satisfying the following function:
H=H₁₂₇× (D/127)^{0.5}, in the function: H₁₂₇∈[2.5 mm, 4.0 mm], D is the ball diameter, H₁₂₇ is the hole diameter when the ball diameter D is 127 mm.

2. The self-inflating ball as claimed in claim 1, wherein the ball diameter D is 125-300 mm.

3. The self-inflating ball as claimed in claim 1, wherein the wall thickness T is 2.0-10.0 mm.

4. The self-inflating ball as claimed in claim 1, wherein the hole diameter H is 1.5-6.0 mm.

5. The self-inflating ball as claimed in claim 1, wherein the T₁₂₇ is 3.7 mm, and the H₁₂₇ is 4.0 mm.

6. The self-inflating ball as claimed in claim 1, wherein the vent hole has a circular cross-section.

7. The self-inflating ball as claimed in claim 1, wherein the hollow ball body is made of elastic rubber.

8. The self-inflating ball as claimed in claim 1, wherein a reinforcing protrusion is integrally formed on an inner wall and/or outer wall of the hollow ball body, surrounding an outer periphery of the vent hole.

9. The self-inflating ball as claimed in claim 1, wherein the at least one vent hole includes two vent holes.

10. The self-inflating ball as claimed in claim 1, wherein the hollow ball body after inflation has a rebound rate of greater than or equal to 48%, the rebound rate is the ratio of a height to which the hollow ball body bounces to a height from which the hollow ball body is dropped, and the height from which the hollow ball body is dropped is 150 cm.
